(19) United States
(12) Patent Application Publication
(10) Pub. No.: US 2025/0199770 A1
(43) Pub. Date: Jun. 19, 2025

(54) DRAWING APPARATUS, DRAWING METHOD, AND PROGRAM

(71) Applicant: NEC Corporation, Minato-ku, Tokyo (JP)

(72) Inventor: Shinichi TORIYAMA, Tokyo (JP)

(73) Assignee: NEC Corporation, Minato-ku, Tokyo (JP)

(21) Appl. No.: 18/851,747

(22) PCT Filed: Mar. 29, 2022
(86) PCT No.: PCT/JP2022/015287

§ 371 Date: Sep. 27, 2024

(51) Int. Cl. G06F 7/58

(52) U.S. Cl. CPC G06F 7/582

(57) ABSTRACT

A drawing apparatus includes: a drawing reception part that allocates a drawing number to an application for a drawing; a random number generation part that generates a random number based on an initial value; and a comparison part that compares the drawing number allocated by the drawing reception part with the random number generated by the random number generation part to determine a drawing result; wherein the initial value used by the random number generation part is set based on a hash value or a nonce in a block header of a block in a public blockchain.

### TECHNICAL FIELD

The present invention relates to a drawing apparatus, a drawing method, and a program.

### BACKGROUND ART

PTL (Patent Literature) 1 relates to a blockchain execution method.

PTL2 relates to a copyright management method in which copyright management transactions are stored in a blockchain.

PTL3 relates to a random number generation system in which random numbers used for games or electronic drawings are generated and fairness of the generated random numbers are verified.

NPL (Non-Patent Literature) 1 relates to Bitcoin.

For example, as disclosed in PTL3, a random number generation system in which random numbers are generated and fairness of the generated random numbers are verified is used for games or electronic drawings.

In addition, for example, in a blockchain such as Bitcoin disclosed in NPL1, a block is made up by aggregating transactions and a hash value in the block header of the previous block is included in the block header of the block, whereby data in the blocks in a blockchain is made unchangeable and thus a ledger is managed on the blockchain.

An individual block approved by a blockchain and added to the blockchain is determined by a consensus-building function such as proof of work (PoW) and so on by individual block generation nodes connected to each other via a peer-to-peer (P2P) network.

### CITATION LIST

### Patent Literature

PTL1: Japanese Patent Kokai Application No. 2021-101579A

PTL2: Japanese Patent Kohyo Application No. 2019-512778A

PTL3: Japanese Patent Kokai Application No. 2018-050973A

### Non-Patent Literature

NPL1: S. Nakamoto, [Bitcoin: A Peer-to-Peer Electronic Cash System], [online], [searched on Mar. 2, 2022], Internet<URL: https://bitcoin.org/bitcoin.pdf>

### SUMMARY

### Technical Problem

The following analysis has been made based on the present invention.

There are cases in which random numbers are generated and used for games, electronic drawings, etc. (for example, on-line drawings). However, random numbers that can be generated by, a deterministic algorithm, a calculation, a logic circuit or the like are pseudo random numbers. As long as a sequence by which numerical values are generated is considered, the generated numerical values seem to be random numbers. However, if random numbers at some points and a calculation algorithm of a random number are known, the random number to be generated next can be easily determined.

Thus, when an on-line drawing or the like is executed by a drawing apparatus which uses random numbers generated by a deterministic algorithm, a calculation, a logic circuit or the like, the participants of the drawing cannot check fairness of the drawing.

It is an object of the present invention is to provide a drawing apparatus, a drawing method, and a program that contribute to allowing a drawing apparatus using random numbers generated by a deterministic algorithm, a calculation, a logic circuit or the like to execute a fair drawing.

### Solution to Problem

According to a first aspect of the present invention, there is provided a drawing apparatus, including:
a drawing reception part that allocates a drawing number to an application for a drawing;
a random number generation part that generates a random number based on an initial value; and
a comparison part that compares the drawing number allocated by the drawing reception part with the random number generated by the random number generation part to determine a drawing result;
wherein the initial value used by the random number generation part is set based on a hash value or a nonce in a block header of a block in a public blockchain.

According to a second aspect of the present invention, there is provided a drawing method, including:
executed by a computer,
a drawing reception step of allocating a drawing number to an application for a drawing;
a random number generation step of generating a random number based on an initial value;
a comparison step of comparing the drawing number allocated in the drawing reception step with the random number generated in the random number generation step to determine a drawing result; and
a step of setting the initial value used in the random number generation step based on a hash value or a nonce in a block header of a block in a public blockchain.

According to a third aspect of the present invention, there is provided a program, causing a computer to execute:
a drawing reception processing for allocating a drawing number to an application for a drawing;
a random number generation processing for generating a random number based on an initial value;
a comparison processing for comparing the drawing number allocated in the drawing reception processing with the random number generated in the random number generation processing to determine a drawing result; and
a processing for setting the initial value used in the random number generation processing based on a hash value or a nonce in a block header of a block in a public blockchain. This program can be recorded in a computer-readable storage medium. The storage medium may be a non-transitory storage medium such as a semiconductor memory, a hard disk, a magnetic recording medium, an optical recording medium or the like. The present invention can be embodied as a computer program product.

### Advantageous Effects of Invention

According to the present invention, it is possible to provide a drawing apparatus, a drawing method, and a program that contribute to allowing a drawing apparatus using random numbers generated by a deterministic algorithm, a calculation, a logic circuit or the like to execute a fair drawing.

### BRIEF DESCRIPTION OF DRAWINGS

FIG. 1 is a diagram illustrating an example of a schematic configuration of a drawing apparatus according to an example embodiment of the present invention.

FIG. 2 is a diagram illustrating an example of a schematic overall configuration including a drawing apparatus according to a first example embodiment of the present invention.

FIG. 3 is a diagram illustrating an example of another configuration of a random number generation part in the drawing apparatus according to the first example embodiment of the present invention.

FIG. 4 is a diagram illustrating an example of hash calculation of a block header in a public blockchain.

FIG. 5 is a diagram illustrating an example of a configuration of a block header hash calculation part in the drawing apparatus according to the first example embodiment of the present invention.

FIG. 6 is a flowchart illustrating an example of a schematic operation of the drawing apparatus according to the first example embodiment of the present invention.

FIG. 7 is a diagram illustrating an example of a schematic overall configuration including a drawing apparatus according to a second example embodiment of the present invention.

FIG. 8 is a flowchart illustrating an example of a schematic operation of a determination part in the drawing apparatus according to the second example embodiment of the present invention.

FIG. 9 is a diagram illustrating a configuration of a computer making up a drawing apparatus according to the present invention.

### DETAILED DESCRIPTION

First, an outline of an example embodiment of the present invention will be described with reference to drawings. Note, in the following outline, reference signs of the drawings are denoted to each element as an example for the sake of convenience to facilitate understanding, however, the present invention is not limited thereto. An individual connection line between blocks in the drawings, etc., referred to in the following description includes both one-way and two-way directions. A one-way arrow schematically illustrates a principal signal (data) flow and does not exclude bidirectionality.

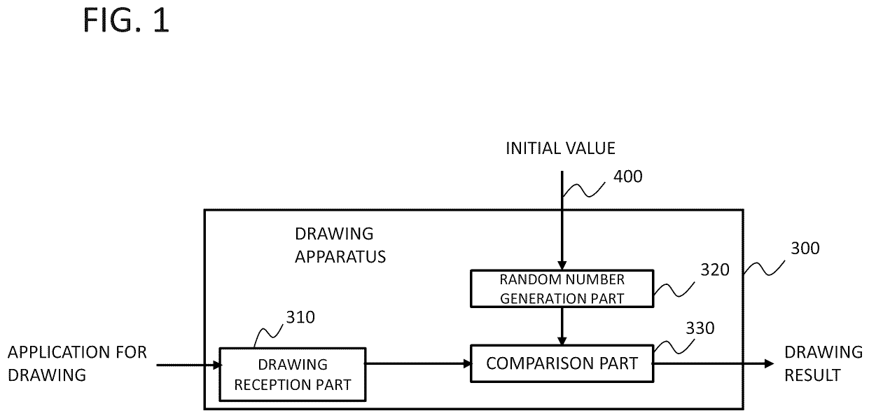

FIG. 1 is a diagram illustrating an example of a schematic configuration of a system according to an example embodiment of the present invention. As illustrated in FIG. 1, a drawing apparatus 300 includes a drawing reception part 310, a random number generation part 320, and a comparison part 330. The drawing reception part 310 allocates a drawing number to an application for a drawing. The random number generation part 320 generates a random number based on an initial value 400. The comparison part 330 compares the drawing number allocated by the drawing reception part 310 with the random number generated by the random number generation part 320 to determine a drawing result. The initial value used by the random number generation part 320 is set based on a hash value or a nonce in the block header of a block in a public blockchain.

In a public blockchain for cryptocurrency such as Bitcoin, Ethereum or the like, with a consensus-building function such as proof of work (PoW) and so on for determining a block generation node, a block generation node is randomly determined at certain intervals. In other words, this is like rolling dice in front of people all around the world at certain intervals, and has properties of a random number, that is, randomness, unpredictability, and non-reproducibility.

Since the initial value used by the random number generation part 320 is set based on a hash value or a nonce in the block header of a block in a public blockchain, a random number shared by worldwide nodes and generated at certain intervals can be used as the initial value or a Seed by the random number generation part 320 to generate a new random number, whereby, a fair random number can be generated.

According to the example embodiment of the present invention, the random number generation part 320 in the drawing apparatus 300 using random numbers generated by a deterministic algorithm, a calculation, a logic circuit or the like can generate fair random numbers. Thus, it is possible to provide the drawing apparatus 300 that contributes to be able to execute a fair drawing.

### First Example Embodiment

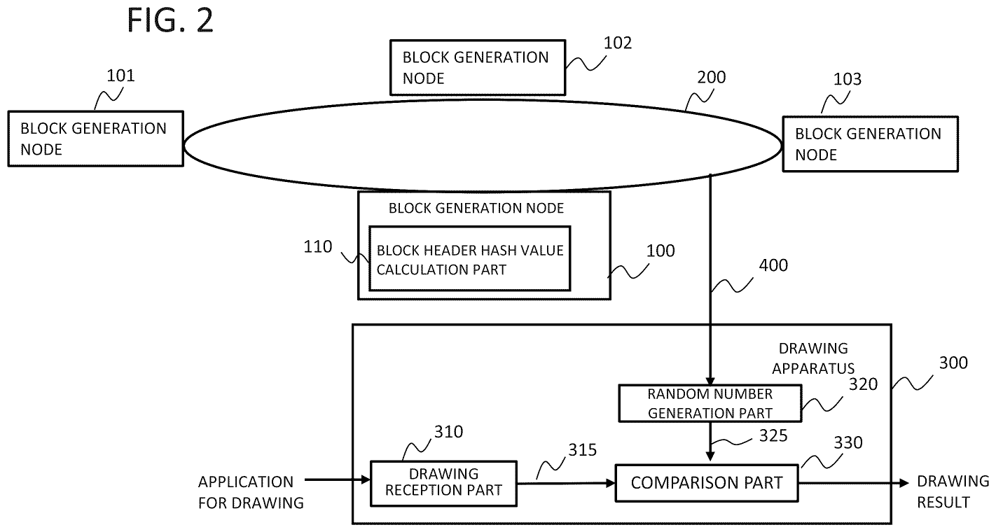

Next, an example of a schematic configuration of a drawing apparatus according to a first example embodiment of the present invention will be described with reference to drawings. FIG. 2 is a diagram illustrating an example of a schematic overall configuration including the drawing apparatus according to the first example embodiment of the present invention. In FIG. 2, components denoted by the same reference signs as those in FIG. 1 indicate the same components, and description thereof will be omitted.

As illustrated in FIG. 2, block generation nodes 100, 101, 102, and 103 in a public blockchain are connected peer-to-peer through a network 200. The block generation node 100 includes a block header hash value calculation part 110. Although the other block generation nodes 101, 102, and 103 also have the same configuration as that of the block generation node 100, the illustration thereof is omitted. A drawing apparatus 300 includes a drawing reception part 310, a random number generation part 320, and a comparison part 330. A hash value or a nonce in the block header of a block generated by the block generation nodes 100, 101, 102 and 103 is set as an initial value 400 in the random number generation part 320.

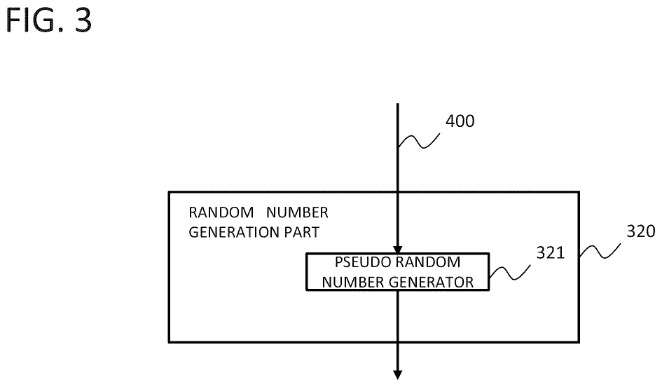

FIG. 3 is a diagram illustrating an example of another configuration of the random number generation part 320 in the drawing apparatus according to the first example embodiment of the present invention. The random number generation part 320 may include a pseudo random number generator 321 that generates a random number based on a deterministic algorithm, calculation, a logic circuit or the like, such as a linear congruential method or a linear feedback shift register (LFSR).

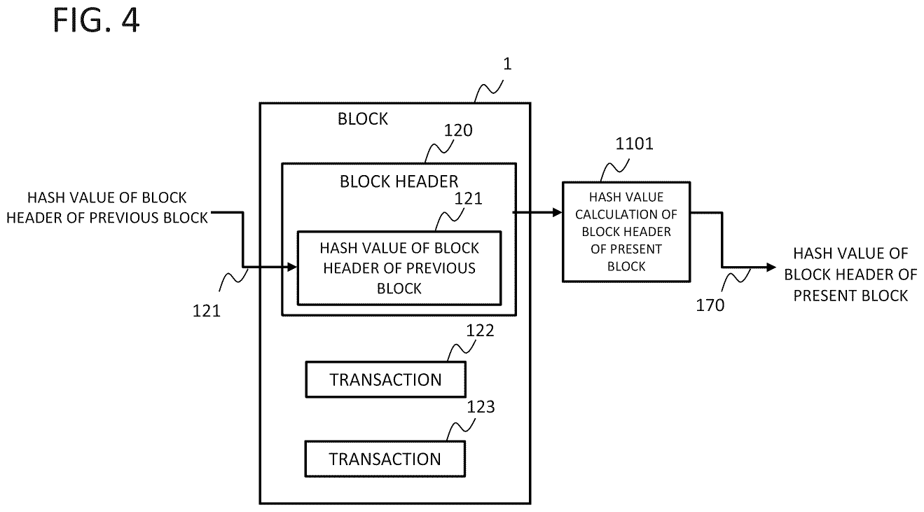

FIG. 4 is a diagram illustrating an example of hash calculation of a block header in a public blockchain. A block generated by the block generation node 100 is made up by, for example, a block header 120, transactions 122, 123, etc., as illustrated in a block 1. The block header 120 includes a hash value 121 of the block header of the previous block. A hash value calculation of a block header of a present block 1101 calculates a hash value 170 of a block header of the present block (block 1) for the block header 120 including the hash value 121 of the block header of the previous block.

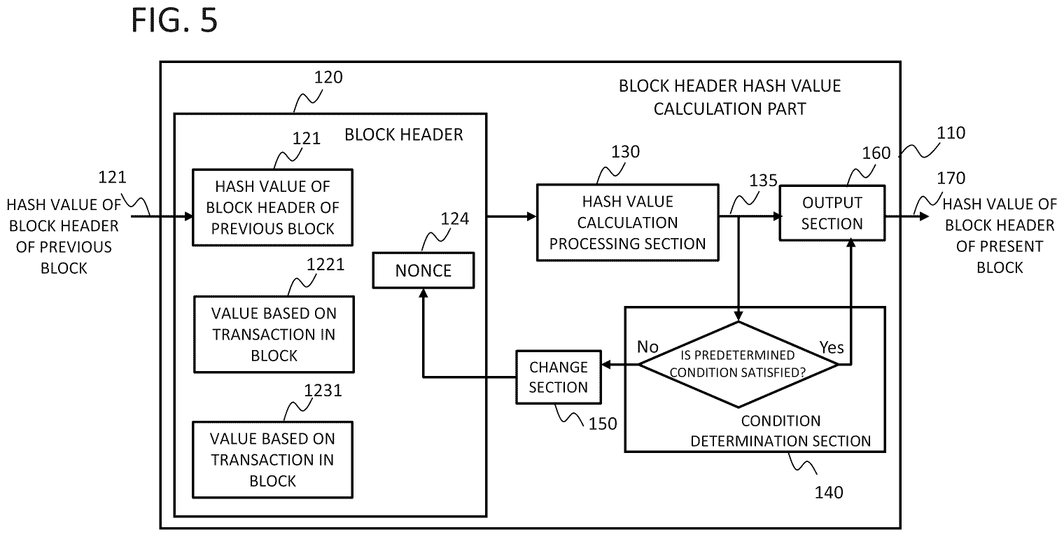

FIG. 5 is a diagram illustrating an example of a configuration of a block header hash calculation part in the drawing apparatus according to the first example embodiment of the present invention. A block header 120 includes a hash value 121 of a block header of a previous block, a value 1221 based on a transaction in a block, a value 1231 based on a transaction in a block, a nonce 124, etc. A hash value calculation processing section 130 calculates a hash value in a block header including the hash value 121 of the block header of the previous block, the value 1221 based on the transaction in the block, the value 1231 based on the transaction in the block, the nonce 124, etc. A condition determination section 140 determines whether a calculated hash value 135 of the block header satisfies a predetermined condition. If the predetermined condition is satisfied (Yes), an output section 160 outputs the calculated block header hash value 135 as a hash value 170 of the block header of the present block. On the other hand, if the predetermined condition is not satisfied (No), a change section 150 changes the value of the nonce, and the hash value in the block header is calculated again.

As described above, if the calculated hash value satisfies the predetermined condition, the block to which the block header hash value 170 is obtained is transmitted peer-to-peer to the other block generation nodes 101, 102, and 103 through the network 200, a consensus-building is made, and the block is approved.

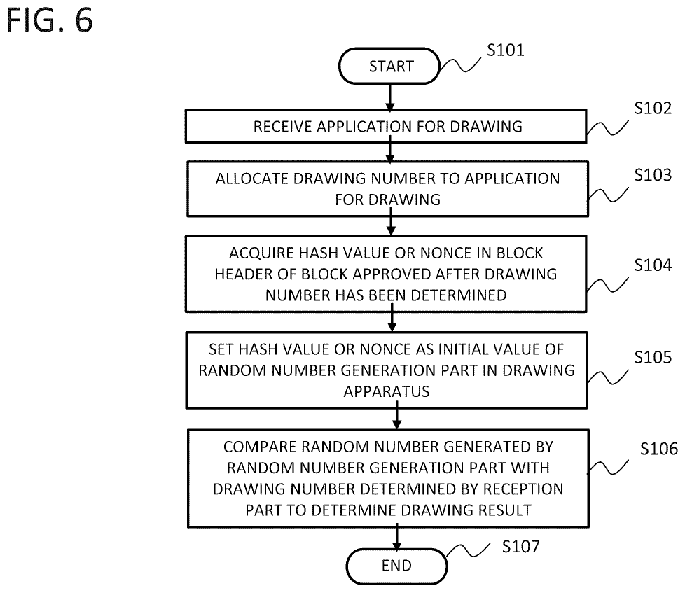

Next, an example of a schematic operation of the drawing apparatus according to the present invention will be described. FIG. 6 is a flowchart illustrating an example of a schematic operation of the drawing apparatus according to first example embodiment of the present invention. The operation starts in step S101.

Next, in step S102, the drawing reception part 310 receives an application for a drawing.

Next, in step S103, the drawing reception part 310 allocates a drawing number 315 to the application for the drawing.

Next, in step S104, a hash value or a nonce in a block header of a block in a public blockchain approved after the drawing number has been determined is acquired. In step S105, the hash value or the nonce in the block header is set as an initial value to the random number generation part in the drawing apparatus. When a plurality of different types of public blockchains are targets, the initial value of the random number generation part 320 may be set based on, among the plurality of different types of public blockchains, a hash value or a nonce in the block header of a block in a public blockchain approved at the earliest time after the time at which the drawing number was allocated.

Next, in step S106, the comparison part 330 compares a random number 325 generated by the random number generation part 320 with the drawing number 315 determined by the reception part to determine a drawing result.

Since the initial value of the random number generation part 320 is set based on a hash value or a nonce in the block header of a block in a public blockchain, it is possible to generate a fair random number by generating a new random number by the random number generation part 320 using a random number generated at certain intervals and shared by worldwide nodes as an initial value or a seed.

According to the first example embodiment of the present invention, the random number generation part 320 in the drawing apparatus 300 using random numbers generated by a deterministic algorithm, a calculation, a logic circuit or the like can generate fair random numbers, whereby it is possible to provide the drawing apparatus 300 that contributes to be able to execute a fair drawing.

### Second Example Embodiment

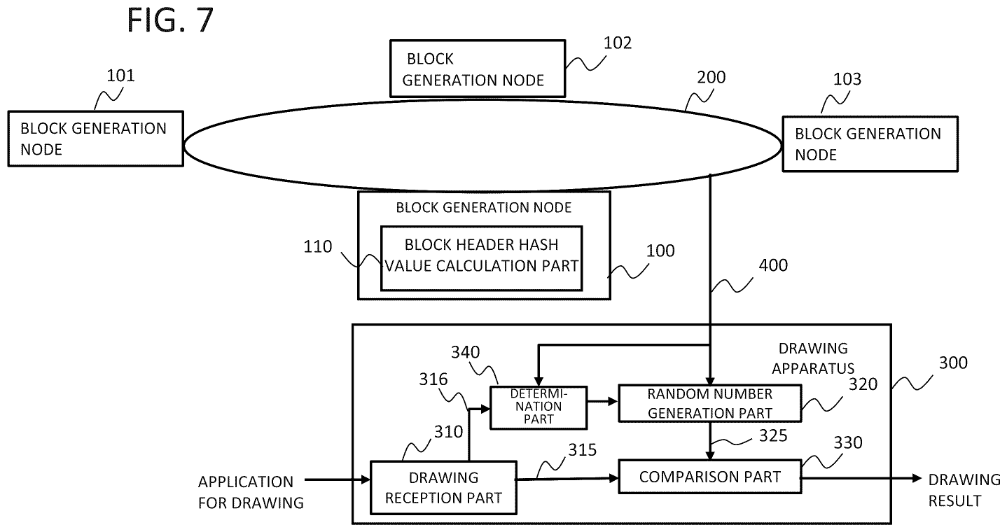

Next, an example of a schematic configuration of a drawing apparatus according to a second example embodiment of the present invention will be described with reference to drawings. FIG. 7 is a diagram illustrating an example of a schematic overall configuration including the drawing apparatus according to the second example embodiment of the present invention. In FIG. 7, components denoted by the same reference signs as those in FIG. 2 indicate the same components, and description thereof will be omitted.

FIG. 7 is an example embodiment obtained by adding a determination part 340 to the drawing apparatus 300 according to the first example embodiment. The determination part 340 determines, based on a time stamp in a block header of a block and a time at which a drawing number was allocated, whether or not a hash value or a nonce in the block header of the block has been approved after the time at which the drawing number was allocated.

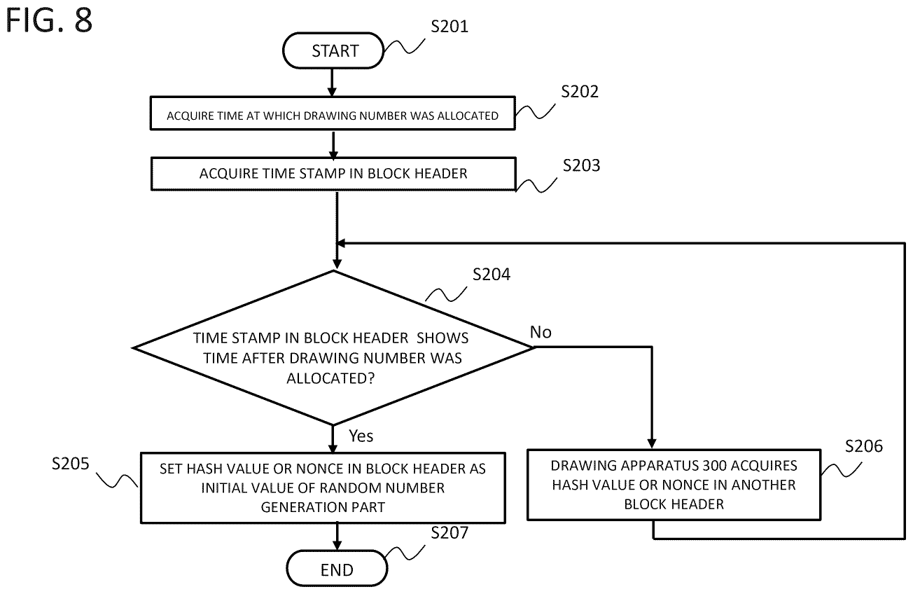

FIG. 8 is a flowchart illustrating an example of a schematic operation of the determination part 340 in the drawing apparatus according to the second example embodiment of the present invention. The operation starts in step S201.

In step S202, the determination part 340 acquires a time 316 at which the drawing number was allocated from a drawing reception part 310.

In step S203, the determination part 340 acquires a time stamp in the block header from the block header of an initial value 400.

In step S204, the determination part 340 determines whether or not the time stamp in the block header has been approved after the time at which the drawing number was allocated.

If an approval is done after the time at which the drawing number was allocated (Yes in step S204), the hash value or the nonce in the block header is set as the initial value of the random number generation part 320 in step S205. On the other hand, if an approval is not done after the time at which the drawing number was allocated (No in step S204), the drawing apparatus 300 acquires a hash value or a nonce in another block header in step S206. The operation ends in step S207.

According to the second example embodiment of the present invention, a hash value or a nonce in a block header of a block approved after the drawing reception part 310 allocates a drawing number to an application for a drawing is set as an initial value of the random number generation part 320. As a result, a fair drawing can be executed.

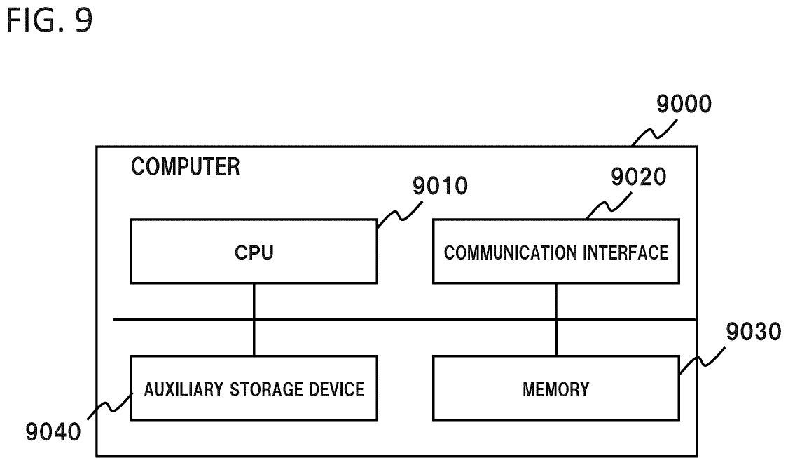

The procedures illustrated in the above example embodiment to the second example embodiment can each be realized by a program that causes an information processing apparatus or the like, for example, a computer (9000 in FIG. 9), functioning as the corresponding drawing apparatus 300, to realize the functions as the corresponding drawing apparatus 300. The computer is, for example, configured to include a central processing unit (CPU) 9010, a communication interface 9020, a memory 9030, and an auxiliary storage device 9040 in FIG. 9. That is, the CPU 9010 in FIG. 9 executes a drawing program and executes a process for updating various calculation parameters stored in the auxiliary storage device 9040, etc.

The memory 9030 is a random-access memory (RAM), a read-only memory (ROM), or the like.

That is, the individual part (processing means or function) of the system according to any one of the above example embodiment to the second example embodiment can be realized by a computer program that causes a processor of the above computer, using corresponding hardware, to execute a corresponding process described above.

Finally, suitable modes of the present invention will be summarized.

### Mode 1

(See the drawing apparatus according to the above first aspect)

### Mode 2

In the drawing apparatus according to mode 1, it is preferable that the hash value or the nonce in the block header is a hash value or a nonce in a block header of a block approved after the drawing reception part allocated the drawing number to the application for the drawing.

### Mode 3

It is preferable that the drawing apparatus according to mode 2 further includes: a determination part that determines, based on a time stamp in the block header of the block and a time at which the drawing number was allocated, whether or not the hash value or the nonce in the block header of the block has been approved after the time at which the drawing number was allocated.

### Mode 4

In the drawing apparatus according to mode 1, it is preferable that the random number generation part includes a pseudo random number generator.

### Mode 5

In the drawing apparatus according to mode 1, it is preferable that the initial value used by the random number generation part is set based on, among a plurality of different types of public blockchains, a hash value or a nonce in a block header of a block in a public blockchain approved at an earliest time after a time at which the drawing number was allocated.

### Mode 6

(See the drawing method according to the above second aspect)

### Mode 7

In the drawing method according to mode 6, it is preferable that the hash value or the nonce in the block header is a hash value or a nonce in a block header of a block approved after the drawing number was allocated to the application for the drawing in the drawing reception step.

### Mode 8

It is preferable that the drawing method according to mode 7 further includes:
executed by the computer,
a determination step of determining, based on a time stamp in the block header of the block and a time at which the drawing number was allocated, whether or not the hash value or the nonce in the block header of the block has been approved after the time at which the drawing number was allocated.

### Mode 9

(See the program according to the above third aspect)

### Mode 10

In the program according to mode 9, it is preferable that the hash value or the nonce in the block header is a hash value or a nonce in a block header of a block approved after the drawing number was allocated to the application for the drawing in the drawing reception processing. The above mode 6 can be expanded to modes 4 and 5, and the above mode 9 can be expanded to modes 3 to 5.

The disclosure of each of the above PTLs and the above NPL is incorporated herein by reference thereto. Modifications and adjustments of the example embodiments or examples are possible within the scope of the overall disclosure (including the claims) of the present invention and based on the basic technical concept of the present invention. Various combinations or selections of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed as being concretely disclosed.

### REFERENCE SIGNS LIST

100, 101, 102, 103 block generation node
110 block header hash value calculation part
120 block header
121 hash value of block header of previous block
122, 123 transaction
124 nonce
130 hash value calculation processing section
140 condition determination section
150 change section
160 output section
170 hash value of block header of present block (block 1)
200 peer-to-peer network
300 drawing apparatus
310 drawing reception part
320 random number generation part
321 pseudo random number generator
330 comparison part
340 determination part
400 initial value
1101 hash value calculation of block header of present block
1221, 1231 value based on transaction in block
9000 computer
9010 CPU
9020 communication interface
9030 memory
9040 auxiliary storage device

What is claimed is:

1. A drawing apparatus, comprising:
at least a processor; and
a memory in circuit communication with the processor,
wherein the processor is configured to execute program instructions stored in the memory to perform:
allocating a drawing number to an application for a drawing;
generating a random number based on an initial value; and
comparing the drawing number allocated with the random number generated by the random number generation part to determine a drawing result;
wherein the initial value used by the random number generation is set based on a hash value or a nonce in a block header of a block in a public blockchain.

2. The drawing apparatus according to claim 1; wherein the hash value or the nonce in the block header is a hash value or a nonce in a block header of a block approved after the allocating the drawing number to the application for the drawing.

3. The drawing apparatus according to claim 2, wherein the processor is configured to execute program instructions stored in the memory to perform:
determining, based on a time stamp in the block header of the block and a time at which the drawing number was allocated, whether or not the hash value or the nonce in the block header of the block has been approved after the time at which the drawing number was allocated.

4. The drawing apparatus according to claim 1; wherein the random number generation part includes a pseudo random number generation.

5. The drawing apparatus according to claim 1; wherein the initial value used by the random number generation is set based on, among a plurality of different types of public blockchains, a hash value or a nonce in a block header of a block in a public blockchain approved at an earliest time after a time at which the drawing number was allocated.

6. A drawing method, comprising:
executed by a computer,
a drawing reception of allocating a drawing number to an application for a drawing;
generating a random number based on an initial value;
comparing the drawing number allocated with the random number generated in the random number generation to determine a drawing result; and
setting the initial value used in the random number generation based on a hash value or a nonce in a block header of a block in a public blockchain.

7. The drawing method according to claim 6; wherein the hash value or the nonce in the block header is a hash value or a nonce in a block header of a block approved after the drawing number was allocated to the application for the drawing in the drawing reception.

8. The drawing method according to claim 7, further comprising:
executed by the computer,
determining, based on a time stamp in the block header of the block and a time at which the drawing number was allocated, whether or not the hash value or the nonce in the block header of the block has been approved after the time at which the drawing number was allocated.

9. A computer-readable non-transitory recording medium recording a program, wherein the program causes a computer to execute:
a drawing reception processing for allocating a drawing number to an application for a drawing;
a random number generation processing for generating a random number based on an initial value;
a comparison processing for comparing the drawing number allocated in the drawing reception processing with the random number generated in the random number generation processing to determine a drawing result; and
a processing for setting the initial value used in the random number generation processing based on a hash value or a nonce in a block header of a block in a public blockchain.

10. The medium according to claim 9; wherein the hash value or the nonce in the block header is a hash value or a nonce in a block header of a block approved after the drawing number was allocated to the application for the drawing in the drawing reception processing.

11. The drawing method according to claim 6; wherein the random number generation includes a pseudo random number generation.

12. The drawing method according to claim 6; wherein the initial value used by the random number generation is set based on, among a plurality of different types of public blockchains, a hash value or a nonce in a block header of a block in a public blockchain approved at an earliest time after a time at which the drawing number was allocated.

13. The medium according to claim 9, wherein the program causes a computer to execute:
a determination processing for determining, based on a time stamp in the block header of the block and a time at which the drawing number was allocated, whether or not the hash value or the nonce in the block header of the block has been approved after the time at which the drawing number was allocated.

14. The medium according to claim 9; wherein the random number generation processing includes a pseudo random number generation processing.

15. The medium according to claim 9; wherein the initial value used by the random number generation processing is set based on, among a plurality of different types of public blockchains, a hash value or a nonce in a block header of a block in a public blockchain approved at an earliest time after a time at which the drawing number was allocated.
